(19) United States
(12) Patent Application Publication
(10) Pub. No.: US 2013/0316460 A1
(43) Pub. Date: Nov. 28, 2013

(54) UNMANNED AUTOMATIC ALKALINITY MEASURING SYSTEM AND METHOD

(71) Applicant: KOREA INSTITUTE OF GEOSCIENCE AND MINERAL RESOURCES, Daejeon (KR)

(72) Inventors: Jeong-Chan KIM, Daejeon (KR); Ki-Sung SUNG, Incheon (KR); Gi-Tak CHAE, Daejeon (KR)

(73) Assignee: KOREA INSTITUTE OF GEOSCIENCE AND MINERAL RESOURCES, Daejeon (KR)

(21) Appl. No.: 13/898,312

(22) Filed: May 20, 2013

(30) Foreign Application Priority Data
May 22, 2012 (KR) 10-2012-0053962

(51) Int. Cl. G01N 35/00

(52) U.S. Cl. CPC G01N 35/00584
USPC 436/50; 422/63

(57) ABSTRACT

Disclosed is unmanned automatic alkalinity measuring system and method. The system periodically and automatically performs collecting, measuring, and draining the sample of leachat or underground water from various sites regularly requiring the inspection or the measurement in the alkalinity thereof, without a person, thereby improving the convenience and the effectiveness in sample measurement.

### CROSS-REFERENCE TO RELATED APPLICATION

This application claims the benefit under 35 U.S.A. §119 of Korean Patent Application No. 10-2012-0053962 filed on May 22, 2012 in the Korean Intellectual Property Office, the entirety of which is incorporated herein by reference.

### BACKGROUND OF THE INVENTION

1. Field of the Invention

The present invention relates to an unmanned automatic alkalinity measuring system, capable of automatically measuring the quality (alkalinity) of water, which requires the regular measurement in ingredients thereof, without a person, and an unmanned automatic alkalinity measuring method. In more particular, the present invention relates to an unmanned automatic alkalinity measuring system, capable of periodically performing processes of automatically collecting the sample (water) of the leachat from a water and sewage treatment plant and a landfill, the leachat from a livestock burial site, the underground water of a radioactive waste burial site, the underground water of a CO₂ geological storage site, gushout water (mineral water or spring), or underground water used as drinking water, which regularly requires the inspection or the measurement in the water quality, measuring the alkalinity of the sample, and draining the sample without a person, thereby improving the convenience and the effectiveness in sample measurement, and an unmanned automatic alkalinity measuring method.

2. Description of the Related Art

As generally known to those skilled in the art, since the leachat from a water and sewage treatment plant and a landfill, the leachat from a livestock burial site, the underground water of a radioactive waste burial site, and the underground water of a CO₂ geological storage site exert a harmful influence on a water pollution environment, the water must be managed through the regular measurement or regular inspection thereof. In addition, since gushout water (mineral water or spring) and underground water used as drinking water may exert an influence on the health of a user, they must be periodically measured or inspected in order to manage whether they are suitable for drinking water. However, according to the conventional scheme of measuring alkalinity of water, since a measurer visits target sites one by one, the measure not only feels inconvenient, but also the measurement costs such as personal expenses of measurement manpower are excessively required. Accordingly, the conventional schemes are uneconomical. Particularly, in the cases of the landfill, the livestock burial site, and the radioactive waste burial site, although the regular measurement of alkalinity is required at a short period of time, the access of a person that collects samples is seriously restricted, so that the measurement of water alkalinity cannot be frequently measured.

In order to conventionally measure the water quality or the alkalinity at a solution, after the measurer visits the target site to collect a sample of the solution, the sample is measured through a preset scheme, and the measurement data are recorded and stored. The measurement items of water quality except for the alkalinity can be measured through an unmanned automatic measuring scheme based on an ion selective electrode or an optical sensor. However, the alkalinity cannot be directly measured in an underground water tube or an observation hole of the leachat by using the ion selective electrode due to the chemical characteristics of ingredients of the solution. In addition, since the alkalinity is sensitive to the variation of temperature or the variation of pH, it is preferred that the alkalinity is directly measured in the field. According to the conventional scheme of measuring the alkalinity, after collecting a predetermined amount of a water sample, an acid solution having known ingredients and known concentration is put into the water sample, so that the variation in the pH of the water sample is recorded and the exact equivalence point is determined. Then, the alkalinity concentration (meq/L) is calculated. This scheme is called by Gran titration. Since Gran titration is generally known to those skilled in the art, the details of the scheme of measuring the alkalinity will be omitted for clarity, and the alkalinity measurement is performed based on the conventional technology.

The conventional technologies on the water quality measurement related to the present invention are disclosed in Korean Unexamined Patent Publication Nos. 2001-0086342 and 2001-0032693, and Korean Patent Application No. 2007-0065791.

### SUMMARY OF THE INVENTION

The prevent invention has been made in an effort to solve the above-described problems, and an object of the present invention is to provide an unmanned automatic alkalinity measuring system, capable of periodically performing processes of automatically collecting, measuring, and draining the sample (water) of the leachat from a water and sewage treatment plant and a landfill, the leachat from a livestock burial site, the underground water of a radioactive waste burial site, the underground water of a CO₂ geological storage site, gushout water (mineral water or spring), or underground water used as drinking water, which regularly requires the inspection or the measurement in the alkalinity thereof, without a person, thereby improving the convenience and the effectiveness in sample measurement, and an unmanned automatic alkalinity measuring method.

In order to accomplish the above object of the present invention, according to one aspect of the present invention, there provided an unmanned automatic alkalinity measuring system. The system includes a sample container to contain a sample for measurement, a water collecting part to collect the sample for measurement, an inspection solution inputting part to input an inspection solution in order to measure the sample for measurement, a controller to store data measured by using the inspection solution and to control the unmanned automatic alkalinity measuring system, and a drain part to drain the sample for measurement from the sample container after measurement of the sample has been finished.

Preferably, the system may include a diluting part installed in the sample container to uniformly dilute the inspection solution with the sample for measurement.

Preferably, the controller may include a storage unit to store measurement data and a data transmission unit to transmit the measurement data, which are stored in the storage unit, to a remote place through wired or wireless communication.

Preferably, the water collecting part may include a motor to pump the sample for measurement, a valve and a pipe to guide the sample for measurement, which is pumped by the motor, to the sample container, and a discharge pipe to remove bubbles from the sample for measurement.

Preferably, an acid solution having a preset concentration may be input through the inspection solution inputting part, an upper portion of the sample container may have a cone shape, and a pressure sustaining valve may be provided at the upper portion of the sample container to sustain a pressure by draining the sample.

According to another aspect of the present invention, there is provided an unmanned automatic alkalinity measuring method. The method includes collecting a sample for measurement by a motor driven according to a control signal, stopping the collecting of the sample for measurement and automatically injecting an inspection solution, if the sample for measurement is filled in a sample container, automatically injecting the inspection solution while measuring the pH of the sample for measurement, storing ingredient data of the sample for measurement in a storage medium and transmitting the ingredient data to a remote place, draining the sample for measurement to evacuate the sample container if the measurement of the sample has been finished, and repeatedly performing above processes in sequence after a preset time elapses.

Preferably, a diluting part may be installed in the sample container to uniformly dilute the inspection solution with the sample for measurement, and the inspection solution and the sample for measurement may be uniformly diluted by the diluting part.

Preferably, the sample container may be cleaned at least three times before and after the measurement is performed.

As described above, according to the present invention, the processes of automatically collecting, measuring, and draining the sample (water) of the leachat from a water and sewage treatment plant and a landfill, the leachat from a livestock burial site, the underground water of a radioactive waste burial site, the underground water of a CO₂ geological storage site, gushout water (mineral water or spring), or underground water used as drinking water, which regularly requires the inspection or the measurement in the alkalinity thereof, can be periodically performed without a person, thereby improving the convenience and the effectiveness in sample measurement.

### BRIEF DESCRIPTION OF THE DRAWINGS

FIG. 1 is a view showing the structure of an unmanned automatic alkalinity measuring system according to the present invention.

FIG. 2 is a flowchart showing an unmanned automatic alkalinity measuring method according to the present invention.

### DETAILED DESCRIPTION OF THE INVENTION

Hereinafter, unmanned automatic alkalinity measuring system and method according to an exemplary embodiment of the present invention will be described in detail. In the following description, if detailed description about well-known functions or configurations may make the subject matter of the disclosure unclear, the detailed description will be omitted.

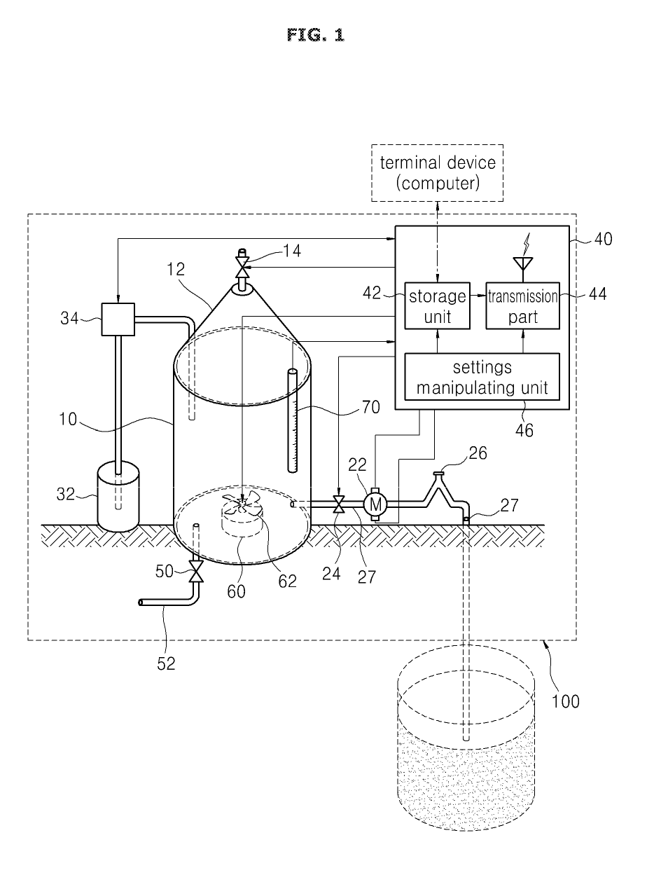

Referring to FIG. 1, an unmanned automatic alkalinity measuring system 100 according to the present invention includes a sample container 10 to contain a sample for measurement, water collecting parts 22, 24, 26, and 27 to collect the sample for measurement, inspection solution inputting parts 32 and 34 inputting an inspection solution in order to measure the sample, a controller 40 to store data measured by using the inspection solution, and to control the unmanned automatic alkalinity measuring system 100, drain parts 50 and 52 to drain the sample from the sample container 10 after the measurement of the sample has been finished, a diluting part 60 installed in the sample container 10 to uniformly dilute the inspection solution with the sample for measurement, and a pH measuring unit 70 to measure the pH of the sample.

A cone-shaped cover 12 is mounted on the sample container 10. The cone-shaped cover 12 is provided therein with a pressure sustaining valve 14 to maintain the pressure existing in the sample container 10. The pressure sustaining valve 14 may be controlled by a controller 40.

The sample-container 10 and the cone-shaped cover 12 may include various materials such as plastic and stainless steel according to the design thereof. Preferably, the sample container 10 may include a material representing superior chemical resistance.

The water collecting parts 22, 24, 26, and 27 may include a motor 22, which is used to pump, that is, pull the sample for measurement from a forebay such as a landfill, a mineral spring, or a well into the sample container 10, a valve 24 and a pipe 27 to guide the sample for measurement, which is pumped by the motor 22, to the sample container 10, and a discharge pipe 26 used to remove or discharge bubbles and gas existing in the forebay.

The inspection solution inputting parts 32 and 34 may include an inspection solution vessel 32 to contain the inspection solution and an inspection solution injecting unit to inject the inspection solution, which is contained in the inspection solution vessel 32, into the sample container 10 under a preset condition. The inspection solution injecting unit 34 may inject the inspection solution into the sample container 10 under the control of the controller 40. The inspection solution may preferably include an acid solution to change the pH of the sample.

The diluting part 60 may include a rotational motor having rotational blades attached thereto in order to dilute the inspection solution with the sample for measurement. The rotational motor of the diluting part 60 may be controlled according to a preset control condition of the controller 40.

If the inspection solution is uniformly diluted with the sample for measurement by the diluting part 60, the pH measuring unit 70 measures the pH value of the sample for measurement and transmits the pH value to the controller 40.

The controller 40 includes a storage unit 42 to store measurement data, the volume of an introduced inspection solution, and the pH value of the inspection solution, a data transmission unit 44 to transmit the data, which are stored in the storage unit 42, to a remote place through wired or wireless communication, and a settings manipulating unit 46 to manipulate the input of various control conditions, and data. Although not shown, the controller 40 may include a display unit to display the operating state and the manipulation conditions of the unmanned automatic alkalinity measuring system 100.

The storage unit 42 may have ports connected to terminal devices, such as a laptop computer, to read/write data stored in the storage unit 42.

The drain parts 50 and 52 include a drain valve 50 and a drain pipe 52 to drain the sample and the inspection solution after the measurement. The drain valve 50 operates under the control of the controller 40.

The controller 40, the motors 22 and 60, the injector 34, and the valves 14, 24, and 50 may receive driving power from a power supply, a battery, or a solar cell.

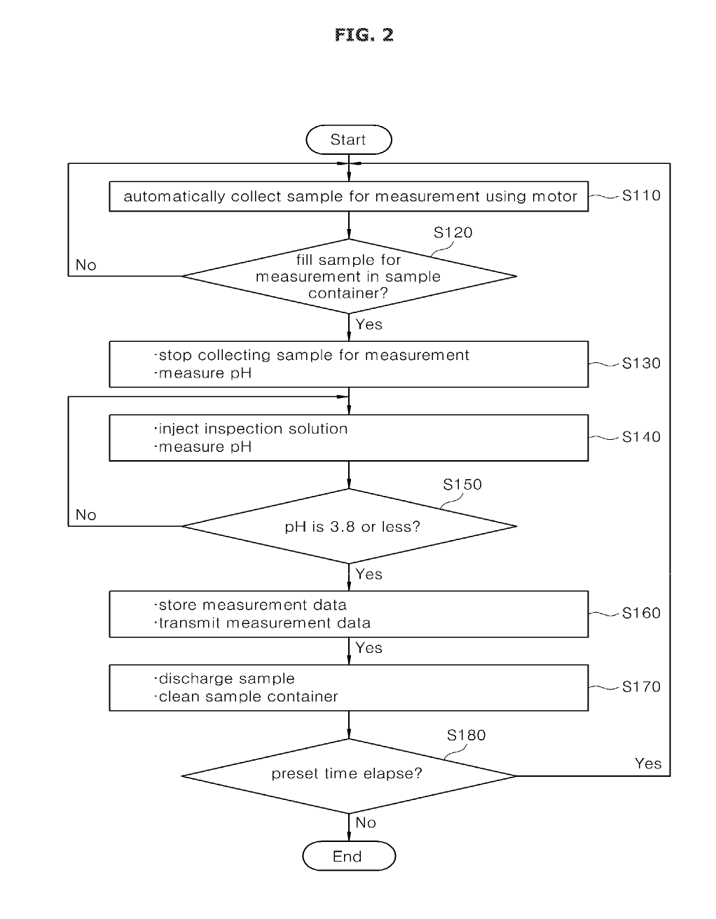

Hereinafter, the operation of the above-constructed unmanned automatic alkalinity measuring system 100 according to the present invention will be described with reference to FIGS. 1 and 2.

First, after the unmanned automatic alkalinity measuring system 100 according to the present invention has been installed in a landfill, a mineral spring, or a well requiring the measurement of water quality (the quality of sample), the measurement period of the sample for measurement is set through the settings manipulating unit 46.

If the measurement period set through the settings manipulating unit 46 arrives, the controller 40 detects the arrival of the measurement period to operate the water collecting motor 22 so that the motor 22 pumps the sample for measurement from the forebay and fills the sample for measurement in the sample container 10 (steps S110 and S120). In this case, the water collecting valve 24 is opened under the control of the controller 40 so that the sample for measurement is smoothly introduced into the sample container 10. When the sample for measurement is filled in the sample container 10, the drain valve 50 is naturally closed.

When the sample for measurement is filled in the sample container 10, bubbles or gas may be drained through the discharge pipe 26. In addition, an amount of pumped samples can be adjusted by the controller 40 to prevent bubbles or gas from being filled in the sample container 10 when the sample for measurement is pumped. In addition, bubbles produced in the sample container 10 may be collected at the upper portion of the cone-shaped cover 12, and discharged through the pressure sustaining valve 14. If samples are sufficiently filled in the sample container 10 without bubbles, the pressure sustaining valve 14 is closed, so that the pressure of the sample is sustained.

If the sample for measurement is filled in the sample container 10 (step S120), the controller 40 stops collecting of the sample by stopping the operation of the water collecting motor 22 and closing the water collecting valve 24, and measures the initial pH of the sample and records the pH (step S130).

After the initial pH has been measured, the controller 40 operates the inspection solution injecting unit 34 to inject an inspection solution, which is contained in the inspection solution vessel 32, into the sample container 10 by a preset amount (step S140).

If the inspection solution is injected into the sample container 10, the controller 40 uniformly dilutes the inspection solution with the sample for measurement by driving the rotational motor 60. Then, the controller 40 measures the measurement value (i.e., pH value) of the ingredients of the sample by the pH measuring unit 70 and stores the pH value into the storage unit 42 (step S140).

The controller 40 operates the inspection solution injecting unit 34 to inject the inspection solution into the sample container 10 by a preset amount until the measurement value of the ingredient of the sample for measurement is a preset value, for example, until the pH value of the sample for measurement is 3.8 (step S150).

If the measured pH value of the sample arrives a preset value as described above, the controller 40 stores the volume of the injected inspection solution and the measured pH value at each step, and transmits the stored measurement data through wired or wireless communication to the remote place, so that the water quality of the target site for measurement can be detected at the remote place (step S160). The wired communication or the wireless communication of the measurement data is performed by the data transmission unit 44 as described above.

If the measurement of the sample has been finished, the controller 40 opens the drain valve 50, completely drains the sample for measurement and the inspection solution, and cleans the sample container 10 which will be described later (step S170).

If the sample for measurement and the inspection solution have been completely drained, the controller 40 operates the water collecting motor 22 and opens the water collecting valve 24 to receive a sample. Then, the controller 40 opens the pressure sustaining valve 14 and cleans the sample container 10 by using the sample. After the controller 40 allows the sample to flow into the sample container 10 for a preset time, the controller 40 closes the water collecting valve 24 and opens the drain valve 50 to completely drain the sample. The controller 40 performs the cleaning process at least three times.

If the preset time elapses after the sample subject to the measurement and the inspection solution have been drained (step S180), the controller 40 repeatedly steps S110 to S170 in sequence.

Therefore, according to the present invention, the alkalinity of water in places such as the landfill, the mineral spring, and the well can be regularly measured or inspected.

Although the exemplary embodiments of the present invention have been described with reference to accompanying drawings, it is understood that the present invention should not be limited to these exemplary embodiments but various changes and modifications can be made by one ordinary skilled in the art within the spirit and scope of the present invention as hereinafter claimed. Accordingly, the true technical protection scope of the present invention is only defined within the scope of accompanying claims.

What is claimed is:

1. An unmanned automatic alkalinity measuring system comprising:
a sample container to contain a sample for measurement;
a water collecting part to collect the sample for measurement;
an inspection solution inputting part to input an inspection solution in order to measure the sample for measurement;
a controller to store data measured by using the inspection solution and to control the unmanned automatic alkalinity measuring system;
a drain part to drain the sample for measurement from the sample container after measurement of the sample has been finished; and
a diluting part installed in the sample container to uniformly dilute the inspection solution with the sample for measurement.

2. The unmanned automatic alkalinity measuring system of claim 1, wherein the diluting part comprises a rotational motor installed at a bottom surface of the sample container and having rotational blades attached thereto to dilute the inspection solution with the sample for measurement.

3. The unmanned automatic alkalinity measuring system of claim 1, wherein the controller comprises a storage unit to store measurement data and a data transmission unit to transmit the measurement data, which are stored in the storage unit, to a remote place through wired or wireless communication.

4. The unmanned automatic alkalinity measuring system of claim 1, wherein the water collecting part comprises a motor to pump the sample for measurement, and a valve and a pipe to guide the sample for measurement, which is pumped by the motor, to the sample container.

5. The unmanned automatic alkalinity measuring system of claim 4, wherein the water collecting part further comprises a discharge pipe to remove bubbles from the sample for measurement.

6. The unmanned automatic alkalinity measuring system of claim 1, wherein the inspection solution comprises an acid solution to change a pH of the sample for measurement.

7. The unmanned automatic alkalinity measuring system of claim 1, wherein an upper portion of the sample container has a cone shape.

8. The unmanned automatic alkalinity measuring system of claim 7, further comprising a pressure sustaining valve provided at the upper portion of the sample container to sustain a pressure.

9. An unmanned automatic alkalinity measuring method comprising:
collecting a sample for measurement by a motor driven according to a control signal;
stopping the collecting of the sample for measurement and measuring a pH of the sample for measurement, if the sample for measurement is filled in a sample container;
automatically injecting an inspection solution if the pH of the sample for measurement is measured, and uniformly diluting the inspection solution with the sample for measurement;
measuring a pH of the sample for measurement diluted with the inspection solution;
storing the measured pH of the sample for measurement and ingredient data of the sample for measurement in a storage medium and transmitting the stored pH and ingredient data to a remote place;
draining the sample for measurement to evacuate the sample container if the measurement of the sample has been finished;
cleaning the sample container if the sample container is evacuated; and
repeatedly performing above processes in sequence after a preset time elapses.

10. The unmanned automatic alkalinity measuring method of claim 9, wherein the cleaning of the sample container comprises:
draining the sample for measurement and the inspection solution which are subject to an inspection by opening a drain valve installed in the sample container;
cleaning the sample container by using a sample for measurement while introducing the sample for measurement into the sample container for a preset time if the draining has been finished; and
stopping the cleaning of the sample container to completely drain the sample for measurement if the preset time elapses.

11. The unmanned automatic alkalinity measuring method of claim 10, wherein the cleaning of the sample container is repeated at least three times.

12. The unmanned automatic alkalinity measuring method of claim 9, wherein the inspection solution comprises an acid solution to change a pH.
